(19) United States
(12) Patent Application Publication
(10) Pub. No.: US 2013/0171491 A1
(43) Pub. Date: Jul. 4, 2013

(54) APPARATUS FOR TRANSFERRING THERMAL ENERGY TO OR FROM A BATTERY CELL

(71) Applicants: Jinzhu Wei, Delta (CA); Stephen Stone, Vancouver (CA); Dawei Chen, Vancouver (CA)

(72) Inventors: Jinzhu Wei, Delta (CA); Stephen Stone, Vancouver (CA); Dawei Chen, Vancouver (CA)

(73) Assignee: PEV Power Systems Inc., Richmond (CA)

(21) Appl. No.: 13/340,741

(22) Filed: Dec. 30, 2011

(51) Int. Cl. H01M 10/50; F28F 99/00

(52) U.S. Cl. 429/120; 165/47

(57) ABSTRACT

An apparatus for transferring thermal energy to or from a battery cell is disclosed, which includes a thermally conductive plate enclosing a conduit in communication with an inlet for receiving a heat transfer fluid stream and being configured to cause the fluid to flow through the plate to an outlet. The plate has a surface for receiving thermal energy generated by operation of the battery cell and is operable to couple thermal energy to the fluid. In one aspect the plate includes first and second opposing walls and the conduit includes a first conduit portion formed in the first wall and a second corresponding conduit portion formed in the second wall defining the conduit. In another aspect the conduit includes an aperture in a central wall and first and second cover walls on either side of the central wall. The cover walls enclose aperture and provide a seal.

### BACKGROUND OF THE INVENTION

1. Field of Invention

This invention relates generally to batteries and more particularly to transferring thermal energy to or from a battery cell.

2. Description of Related Art

Batteries are increasingly being used in applications where it is necessary to remove excess thermal energy generated by battery cells to prevent overheating of the cells. In particular, batteries such as lithium-ion and nickel metal hydride batteries are being used in hybrid and hybrid-electric vehicles and other applications where the cooling requirements are quite substantial. Some battery types are associated with operating risks that significantly increase under overheating conditions. Accordingly, there remains a need for methods and apparatus associated with providing a stable and homogenous operating temperature for battery cells.

### SUMMARY OF THE INVENTION

In accordance with one aspect of the invention there is provided an apparatus for transferring thermal energy to or from a battery cell. The apparatus includes a thermally conductive plate enclosing a conduit. The conduit is in communication with an inlet for receiving a heat transfer fluid stream and is configured to cause the fluid to flow through the thermally conductive plate to an outlet. The thermally conductive plate has a surface for receiving thermal energy generated by operation of the battery cell, the thermally conductive plate being operable to couple thermal energy to the fluid. The thermally conductive plate includes first and second opposing walls. The conduit includes a first conduit portion formed in the first wall and a second corresponding conduit portion formed in the second wall, the first and second conduit portions together defining the conduit.

The apparatus may include a seal enclosing the conduit, the inlet, and the outlet, the first and second walls being urged together to cause the seal to be compressed to prevent fluid from escaping from the thermally conductive plate.

The seal may include a double seal.

The double seal may include first and second seal portions, the first and second seal portions being spaced apart and may further include a plurality of fasteners received between the first and second seal portions for urging the first and second walls together to cause the double seal to be compressed.

The plurality of fasteners may include one of a plurality of threaded fasteners, and a plurality of rivets.

At least one of the first and second walls may include a groove formed in the at least one wall for receiving the seal.

The seal may include a compressible material having a generally circular cross-section.

The first and second walls may include at least one of a metal, a metal alloy, and a thermally conductive polymer.

The conduit may have a cross-section having a width dimension in a plane of the thermally conductive plate and a depth dimension extending generally perpendicular to the plane of the thermally conductive plate and the width dimension may be greater than the depth dimension.

The apparatus may include a sensor conduit for receiving a temperature sensor for generating a signal representing the temperature of the thermally conductive plate.

The thermally conductive plate may have a generally rectangular shape and the inlet and outlet may be respectively disposed at opposite peripheral edges of the thermally conductive plate and the conduit may follow a generally serpentine path between the inlet and the outlet.

At least one of the inlet and the outlet may include an opening extending through the thermally conductive plate between the first and second walls, the opening being in communication with the conduit and being configured to be coupled to a corresponding opening in an adjacently located thermally conductive plate for receiving the fluid stream.

The battery cell may be disposed between the adjacently located thermally conductive plates and may further include a coupling configured to couple the fluid stream between the openings in the adjacently located thermally conductive plates.

The coupling may be dimensioned to cause the adjacently located thermally conductive plates to be spaced apart sufficiently to accommodate the battery cell.

The coupling may be dimensioned to cause the adjacently located thermally conductive plates to be spaced apart sufficiently to accommodate the battery cell while constraining thermal expansion of the battery cell when generating thermal energy during operation.

The coupling may be operably configured to receive a seal for sealing between the coupling and the opening.

The thermally conductive plate may include a plurality of fastener openings extending through the first and second walls, each fastener opening being configured to receive a fastener for holding a plurality of thermally conductive plates and battery cells in an alternating stack configuration for forming a battery apparatus, the fasteners being further operable to constrain thermal expansion of the battery cell when generating thermal energy.

The surface for receiving thermal energy generated by operation of a battery cell may be generally planar and may be dimensioned to generally correspond to a surface of the battery cell that facilitates coupling of thermal energy from the battery cell.

In accordance with another aspect of the invention there is provided a battery apparatus. The apparatus includes at least one battery cell, and a thermally conductive plate disposed in thermal communication with the at least one battery cell, the thermally conductive plate being configured as set forth above.

The battery apparatus may further include first and second end plates disposed on either side of the battery apparatus and the battery apparatus may include a fluid inlet for receiving the fluid stream and a fluid outlet for discharging the fluid stream, the fluid inlet and the fluid outlet being disposed on one of the first and second end plates, the fluid inlet being coupled to the inlet of the thermally conductive plate and the fluid outlet being coupled to the outlet of the thermally conductive plate.

The at least one battery cell may include a plurality of battery cells each being in thermal communication with at least one thermally conductive plate, and the battery apparatus may further include a coupling configured to couple the fluid stream between the adjacently located thermally conductive plates.

The coupling may be dimensioned to cause the adjacent thermally conductive plates to be spaced apart to accommodate the battery cell.

The coupling may be dimensioned to cause the adjacently located thermally conductive plates to be spaced apart sufficiently to accommodate the battery cell while constraining thermal expansion of the battery cell when generating thermal energy during operation.

The thermally conductive plate may include a plurality of fastener openings extending through the first and second walls, and the first and second end plates may include a corresponding plurality of fastener openings extending though the respective end plates, each fastener opening being configured to receive a fastener for holding the end plates, battery cells and the thermally conductive plate in an alternating stack configuration for forming a battery apparatus, the fasteners being further operable to constrain thermal expansion of the battery cell when generating thermal energy.

In accordance with another aspect of the invention there is provided an apparatus for transferring thermal energy to or from a battery cell. The apparatus includes a thermally conductive plate enclosing a conduit. The conduit is in communication with an inlet for receiving a heat transfer fluid stream and is configured to cause the fluid to flow through the thermally conductive plate to an outlet. The thermally conductive plate has a surface for receiving thermal energy generated by operation of the battery cell, the thermally conductive plate being operable to couple thermal energy to the fluid. The conduit includes an aperture in a central wall of the thermally conductive plate, and the thermally conductive plate further includes first and second cover walls on either side of the central wall, the cover walls enclosing the aperture and providing a seal for preventing fluid from escaping from the thermally conductive plate.

The central wall may include one of a plastic material, a metal, and a metal alloy.

The cover walls may include at least one of a metal, a metal alloy, and a thermally conductive polymer.

The central wall may be formed using at least one of a machining process, a molding process, and a stamping process.

The cover walls may be adhered to the central wall to provide the seal.

The central wall may include a groove formed in the central wall and enclosing the conduit, the inlet, and the outlet, the groove being operable to receive an adhesive for providing a seal for preventing fluid from escaping from the thermally conductive plate.

The central wall may include a groove formed in the central wall and enclosing the conduit, the inlet, and the outlet, the groove being operable to receive a seal for preventing fluid from escaping from the thermally conductive plate.

The conduit may have a cross-section having a width dimension in a plane of the thermally conductive plate and a depth dimension extending generally perpendicular to the plane of the thermally conductive plate and the width dimension may be greater than the depth dimension.

The apparatus may include a sensor conduit for receiving a temperature sensor for generating a signal representing the temperature of the thermally conductive plate.

The thermally conductive plate may have a generally rectangular shape and the inlet and outlet may be respectively disposed at opposite peripheral edges of the thermally conductive plate and the conduit follows a generally serpentine path between the inlet and the outlet.

At least one of the inlet and the outlet may include an opening extending through the thermally conductive plate between the first and second walls, the opening being in communication with the conduit and being configured to be coupled to a corresponding opening in an adjacently located thermally conductive plate for receiving the fluid stream.

The battery cell may be disposed between the adjacently located thermally conductive plates and may further include a coupling configured to couple the fluid stream between the openings in the adjacently located thermally conductive plates.

The coupling may be dimensioned to cause the adjacently located thermally conductive plates to be spaced apart sufficiently to accommodate the battery cell.

The coupling may be dimensioned to cause the adjacently located thermally conductive plates to be spaced apart sufficiently to accommodate the battery cell while constraining thermal expansion of the battery cell when generating thermal energy during operation.

The coupling may be operably configured to receive a seal for sealing between the coupling and the opening.

The thermally conductive plate may include a plurality of fastener openings extending through the first and second walls, each fastener opening being configured to receive a fastener for holding a plurality of thermally conductive plates and battery cells in an alternating stack configuration for forming a battery apparatus, the fasteners being further operable to constrain thermal expansion of the battery cell when generating thermal energy.

The surface for receiving thermal energy generated by operation of a battery cell may be generally planar and is dimensioned to generally correspond to a surface of the battery cell that facilitates coupling of thermal energy from the battery cell.

Advantageously, embodiments of the invention facilitate control of the temperature of the battery cell within a desired range by removing thermal energy generated during operation of the battery and/or by delivering thermal energy to the battery.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a perspective view of a battery apparatus in accordance with a first embodiment of the invention;

FIG. 2 is a perspective view of a thermally conductive plate used in the battery apparatus shown in FIG. 1;

FIG. 3 is a plan view of a wall of the thermally conductive plate shown in FIG. 2;

FIG. 4 is a plan view of another wall of the thermally conductive plate shown in FIG. 2;

FIG. 5 is an exploded perspective view of an alternative embodiment of a thermally conductive plate; and

FIG. 6 is a perspective view of the thermally conductive plate shown in FIG. 5 in an assembled condition.

### DETAILED DESCRIPTION

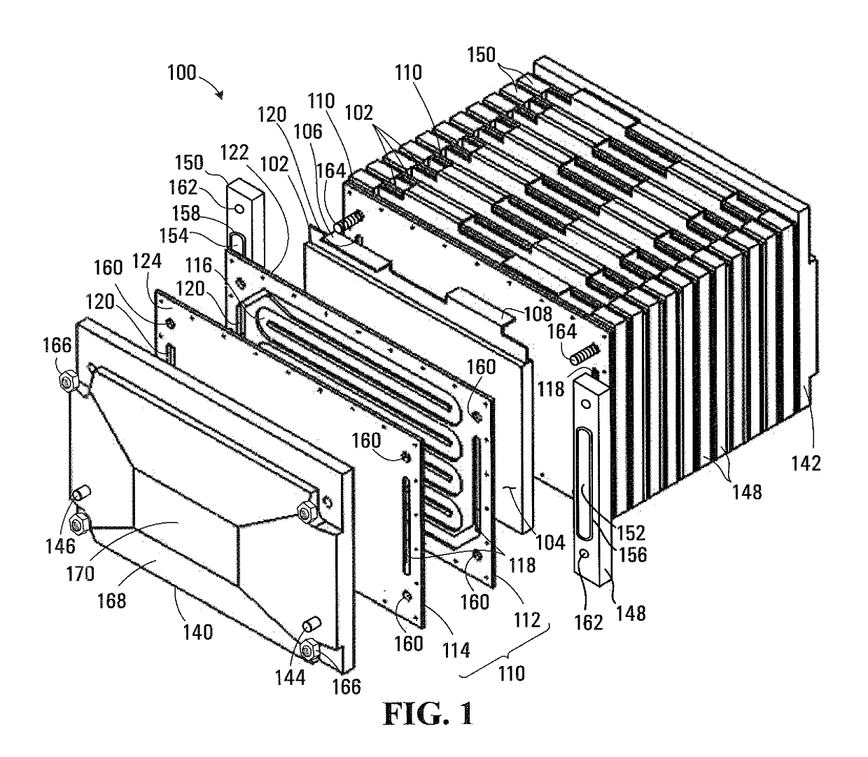

Referring to FIG. 1, a battery apparatus according to a first embodiment of the invention is shown partially in exploded view at 100. The apparatus 100 includes a plurality of battery cells 102, such as lithium-ion battery cells. In this embodiment, each battery cell 102 is enclosed within a covering 104 and includes terminals 106 and 108, which facilitate connection of the cells in series or in parallel to make up a battery having providing a desired terminal voltage and storage capacity. The covering 104 may comprise a metal foil material, for example. In other embodiments, the battery cells 102 may have a different shape, covering, and chemical constitution. The battery cell 102 may be a nickel-metal hydride, lithium-ion polymer, or any of a plurality of different battery cells.

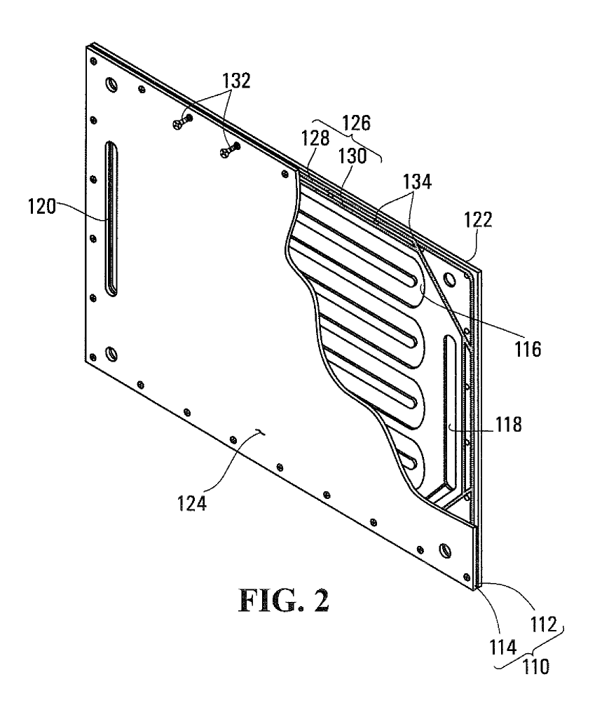

The battery 100 further includes a thermally conductive plate apparatus 110 for cooling or heating the battery cells 102. The thermally conductive plate apparatus 110 is shown in exploded view in FIG. 1 and is shown in an assembled condition in FIG. 2. Referring to FIG. 2, the thermally conductive plate 110 includes first and second opposing walls 112 and 114 enclosing a conduit 116. The conduit 116 is formed between the first and second opposing walls 112 and 114, and is in communication with an inlet 118 for receiving a heat transfer fluid stream. In the embodiment shown in FIG. 2, the conduit extends into, but not through the wall 112. In other embodiments disclosed below the conduit may extend through a central wall as described later.

In the embodiment shown, the conduit 116 has a cross-section having a width dimension in a plane of the thermally conductive plate 110 and a depth dimension extending generally perpendicular to the plane of the thermally conductive plate, and the width dimension is greater than the depth dimension. In other embodiments the cross section of the conduit may have a different aspect ratio to that shown in FIG. 2. Advantageously, for the aspect ratio shown in FIG. 2, the conduit 116 accommodates a flow of heat transfer fluid that has a large area in close thermal contact with a rear surface 122 and/or a front surface 124 of the thermally conductive plate 110.

The thermally conductive plate 110 also includes an outlet 120, and the fluid received at the inlet 118 flows through the thermally conductive plate 110 to the outlet 120. In the embodiment shown, the inlet 118 and the outlet 120 are each defined by an opening extending through the thermally conductive plate between the first and second walls 112 and 114 and each opening is in communication with the conduit 116. Accordingly, the opening defining the inlet 118 permits a portion of the fluid flowing through the opening to flow into the conduit 116, while the opening defining the outlet 120 collects fluid flowing out of the conduit. For the orientation of the battery embodiment shown in FIG. 1, the inlet 118 is in communication with a lower portion of the conduit 116 and the outlet 120, is in communication with an upper portion of the conduit. Advantageously, in the embodiment shown fluid received at the inlet 118 flows into the lower portion of the conduit to the outlet 120 such that the conduit 116 is filled from the lower portion by the fluid flow. This configuration promotes a more uniform flow through the conduit than would be the case if the fluid were received at the outlet 120.

In most embodiments the heat transfer fluid comprises a coolant for removing thermal energy generated during operation of the battery 100. However the inventors have realized that the thermally conductive plate 110 may equally deliver thermal energy to the battery to facilitate operation in low ambient temperature environments, in which case the heat transfer fluid may comprise a heated fluid operable to carry thermal energy to the battery 100. For convenience, the further embodiments disclosed below will generally be described in terms of removing thermal energy from the battery 100. However it should be understood that the heat transfer fluid may equally well be a heated fluid for transporting heat to the thermally conductive plate 110. The heat transfer fluid may be an aqueous liquid, a non-aqueous liquid, and may include one or more additives such as ethylene glycol for example. Alternatively the fluid may be a gaseous coolant such as air or any other gas or mixture of gasses.

In the embodiment shown in FIG. 2, the rear surface 122 of the thermally conductive plate 110 receives thermal energy generated by operation of the battery cell 102. The rear surface 122 is generally planar and is dimensioned to generally correspond to the shape of surfaces of the battery cell that facilitate coupling of thermal energy from the battery cell to the thermally conductive plate 110. In the embodiment shown in FIG. 1 the battery cell 102 is disposed to be assembled in communication with the rear surface 122 of the thermally conductive plate 110, and another battery cell of the plurality of battery cells 102 may be in thermal communication with the front surface 124 of the thermally conductive plate 110.

In operation, the thermally conductive plate 110 is disposed in thermal communication with the covering 104 of the battery cell 102, and thermal energy is transferred between the battery cell and the plate. Thermal energy is in turn transferred between the thermally conductive plate 110 and the fluid flowing through the conduit 116. The thermally conductive plate 110 may be fabricated from metal, metal alloy, or other high thermal conductivity material such as graphite, thermally conductive polymer, or other high-molecular compound, for example. In one embodiment the thermally conductive plate 110 is fabricated from aluminum, which has the advantage of having relatively high thermal conductivity, low cost, and is being easily machined. The conduit 116 may be machined into the wall 112 by end milling, for example.

The thermally conductive plate 110 further includes a seal 126 enclosing the conduit 116, the inlet 118, and the outlet 120, which in this embodiment is implemented as a double seal. The first and second opposing walls 112 and 114 are urged together to cause the double seal 126 to be compressed to prevent fluid from escaping from the thermally conductive plate 110. The double seal 126 includes first and second seal portions 128 and 130, and in this embodiment the walls 112 and 114 of the thermally conductive plate are urged together using a plurality of fasteners 132 received in threaded holes 134 disposed between the first and second seal portions to cause the double seal to be evenly compressed. Alternatively fasteners such as rivets may be used to urge the walls 112 and 114 together to compress the double seal 126. While the embodiment shown in FIG. 2 has been described with reference to a double seal, in other embodiments a single seal or a seal having more than two portions may be used in place of the double seal.

The double seal 126 may include a compressible material having a generally circular cross-section. In one embodiment the double seal 126 may be fabricated in a mold configured to produce a unitary double seal as shown in part in FIG. 2, where the first and second seal portions 128 and 130 are joined together to provide a unitary seal. The seal portions 128 and 130 of the seal 126 may have a generally circular cross section or the cross section of the seal may be rectangular, oval, or another non-circular shape. In an alternative embodiment the double seal may comprise a pair of o-ring seals of suitable dimension for enclosing the inlet 118, outlet 120 and the conduit 116.

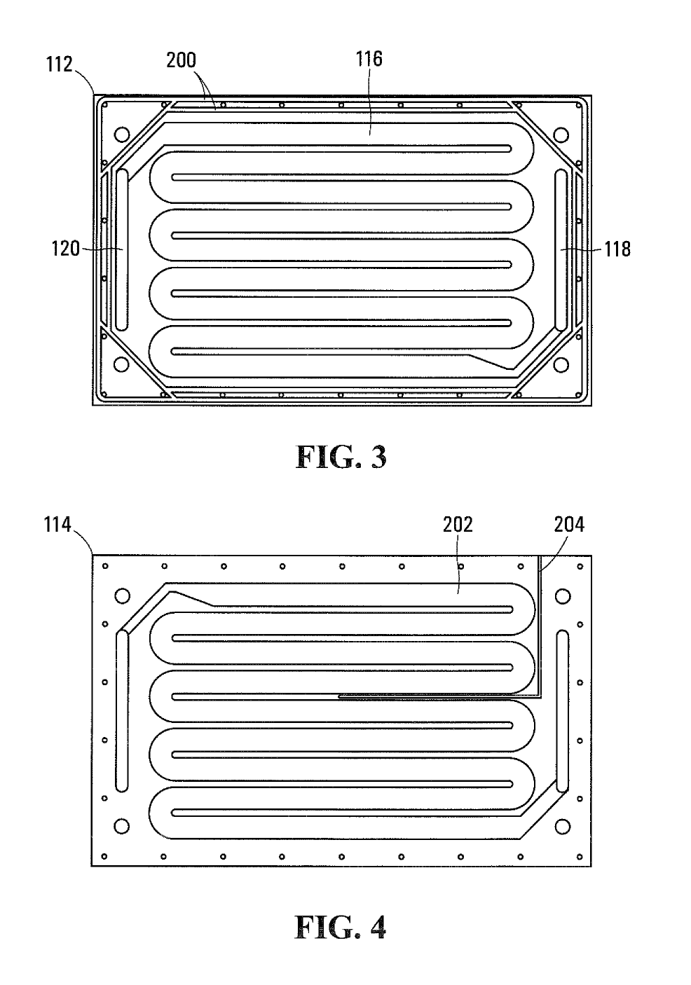

The first wall 112 is shown in plan view in FIG. 3. Referring to FIG. 3, the conduit 116 follows a generally serpentine path between the inlet 118 and the outlet 120, thereby carrying fluid to a substantial portion of thermally conductive plate 110. Various other flow paths may be implemented and the conduit 116 may also divide to cause the flow through the conduit to follow more than one path between the inlet 118 and the outlet 120. In the embodiment shown in FIG. 3 the wall 112 includes a groove 200 formed in the wall for receiving the double seal 126, which has the advantage of positioning the seal prior to assembly of the thermally conductive plate 110.

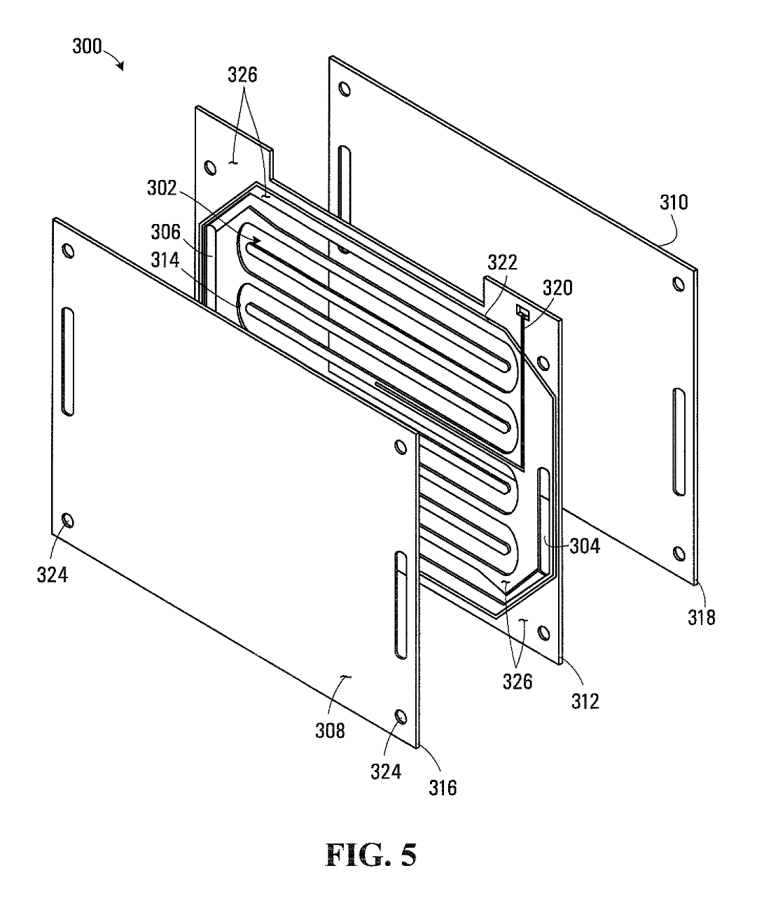

The second wall 114 is shown in plan view in FIG. 4. In one embodiment the conduit 116 may be a first conduit portion formed in the first wall 112 and a second corresponding conduit portion may be formed in the second wall 114, as shown at 202 in FIG. 4. In this case, the first and second conduit portions 116 and 202 together define the conduit. In other embodiments the conduit 116 may be formed only in the first wall 112 and the second wall 114 encloses the conduit 116 in the first wall 112. In the embodiment of the second wall 114 shown in FIG. 4, the wall does not include a groove corresponding to the groove 200 formed in the first wall 112 for receiving the double seal 126. In this case the double seal 126 would be simply compressed into the grove 200 by the second wall 114. In other embodiments the second wall 114 may include a groove corresponding to the groove 200 for receiving and positioning the seal when the walls 112 and 114 are assembled to provide the thermally conductive plate 110.

The second wall 114 also includes a sensor conduit 204 for receiving a temperature sensor (not shown). The temperature sensor may be included in the thermally conductive plate 110 for generating a temperature signal representing the temperature of the plate during operation. Various temperature sensors, such as a solid state temperature sensor, thermistor, or thermocouple, may be used to generate the temperature signal. The temperature signal may be provided to a controller of an apparatus within which the battery is installed (for example, a vehicle) for monitoring purposes. Should a temperature of one of the thermally conductive plates 110 in a battery 100 become elevated above the temperature of other plates, this may indicate a fault condition associated with either the thermally conductive plate 110 or associated with a battery cell 102 in thermal communication with the plate.

Referring back to FIG. 1, the battery 100 further includes a first end plate 140 and a second end plate 142 disposed on either side of the battery. The first end plate 140 includes a heat transfer fluid inlet 144 for receiving the fluid stream and a heat transfer fluid outlet 146 for discharging the fluid stream. In other embodiments, the fluid inlet 144 and fluid outlet 146 may be disposed on the second end plate 142 or the fluid inlet and fluid outlet may each be disposed of either of the first or second end plates. The battery 100 further includes first and second couplings 148 and 150 configured to couple the fluid stream between adjacently located openings in adjacently located thermally conductive plates 110. Each of the couplings 148 and 150 include a respective opening 152 and 154 extending through the coupling for facilitating fluid flow through the coupling between the adjacently located thermally conductive plates 110. In the embodiment shown, the couplings 148 provide for an inlet flow from the heat transfer fluid inlet 144 to each of the thermally conductive plates 110 of the battery 100, while the couplings 150 provide for an outlet flow from each of the plates 110 of the battery to the heat transfer fluid outlet 146. In other embodiments, the battery and couplings may be configured to cause fluid to flow sequentially through thermally conductive plates 110, i.e. from the inlet 118 to the outlet 120 of the first thermally conductive plate, then into the outlet 120 of the second thermally conductive plate, through the conduit 116 to the inlet 118, and so on.

The first and second couplings 148 and 150 are configured to receive respective seals 156 and 158 for sealing between the respective first and second couplings and the corresponding openings of the inlet 118 and outlet 120. In one embodiment the first and second couplings 148 and 150 include respective o-ring grooves for receiving an o-ring seal or other molded seal (not shown). Additional seals for sealing between a rear of the couplers 148 and 150 and a subsequent thermally conductive plate 110 are not visible in FIG. 1, but would be included and would be similar to the seals 156 and 158.

In one embodiment the couplings 148 and 150 are dimensioned such that when the battery 100 is assembled, the thermally conductive plate 110 is spaced apart from the thermally conductive plates 110 (or the first end plate 140) by a distance that is sufficient to accommodate the battery cell 102 between the plates. When an operating temperature of the battery cell 102 becomes elevated during operation or charging, the cell may expand. For some cell types and configurations, such as lithium-ion battery cells, as the state of charge of the cell increases, the cell expands and such expansion may cause damage to the cell due to layer separation. Accordingly, the couplings 148 and 150 may be dimensioned to constrain such thermal expansion of the cell 102 when the battery 100 is assembled, thereby limiting expansion of the cells.

In the embodiment shown in FIG. 1, the thermally conductive plate 110 includes a plurality of fastener openings 160 extending through the first and second walls 112 and 114. The first and second couplings 148 and 150 also have corresponding fastener openings 162. The fastener openings 160 and 162 are configured to receive respective fasteners 164 for holding the plurality of thermally conductive plates 110 and battery cells 102 in an alternating stack configuration. In this embodiment the fasteners 164 are threaded and receive respective nuts 166 for holding the battery 100 in the stacked configuration. The fastener openings 160 are also peripherally located such that the battery cells 102 are disposed between the fasteners 164 when the battery 100 is assembled. The fasteners 164 hold the battery cells 102, thermally conductive plates 110, and couplings 148 and 150 in place while simultaneously compressing the seals 156 and preventing expansion of the battery cells. The first end plate 140 includes a peripheral portion 168 and a central portion 170, and in the embodiment shown in FIG. 1, the central portion is thicker than the peripheral portion to prevent the end plate from bowing when subjected to forces due to the tendency of the battery cells 102 to expand when operating or being changed. The thicker central portion 170 provides greater stiffness in regions of the end plate 140 located inward of the fastener 164. Peripheral portions 168 of the first end plate 140 are sufficiently close to the fasteners 164 to be less susceptible to bowing. The end plate 142 may have similar thicker central portions (not shown in FIG. 1). The end plates may be fabricated from a material such as aluminum that provides a good stiffness to weight ratio. In other embodiments other metals, materials, or composite materials may be used in place of aluminum.

The battery 100 thus includes a plurality of cells 102 and thermally conductive plates 110 in an alternating stack configuration for forming the battery. The battery 100 includes cells 102 having terminals 106 and 108 connected in parallel or in series to provide a desired terminal voltage and capacity.

While the battery apparatus 100 has been described with reference to a generally flat rectangular cell 102, in other embodiments the cells may not be flat and/or may be otherwise shaped and the thermally conductive plate 110 may be correspondingly shaped to accommodate such other shapes.

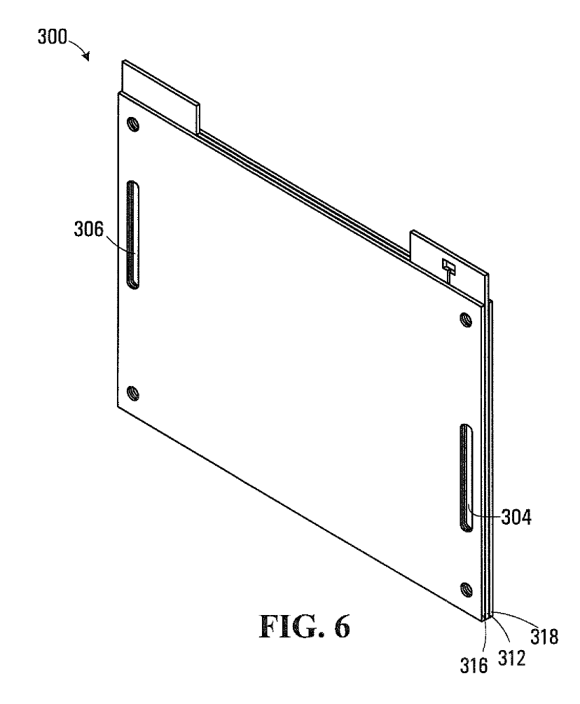

An alternative embodiment of a thermally conductive plate apparatus, which may be used in the battery 100 shown in FIG. 1, is shown in FIG. 5 and FIG. 6 generally at 300. Referring to 5, the thermally conductive plate 300 encloses a conduit 302, which is in communication with an inlet 304 for receiving a heat transfer fluid stream. The conduit 302 is configured to cause the fluid to flow through the thermally conductive plate 300 to an outlet 306.

In this embodiment, the thermally conductive plate 300 includes a central wall 312 and the conduit 302 is defined by an aperture 314 formed in the central wall. The aperture 314 extends through the central wall 312. The thermally conductive plate 300 further includes first and second cover walls 316 and 318 on either side of the central wall 312. The cover walls 316 and 318 enclose the aperture 314 in the central wall 312 to provide a seal for preventing fluid from escaping from the thermally conductive plate 300. As in the case of the embodiment of the thermally conductive plate shown in FIG. 2, the plate 300 includes surfaces 308 and 310 (i.e. the back surface of the cover wall 318) for receiving thermal energy generated by operation of the battery cell. The thermally conductive plate 300 is operable to couple thermal energy to the fluid.

The central wall 312 may be fabricated from metal or plastic material or other suitable material and may be formed by machining, stamping, molding or any other suitable process. Advantageously, molding or stamping processes may be employed to lower fabrication costs of the central wall 312.

The cover walls 316 and 318 may be fabricated from a material having high thermal conductivity, such as a metal, metal alloy, or other high thermal conductivity material such as graphite, thermally conductive polymer, or other high-molecular compound, for example. In one embodiment the cover walls 316 and 318 are fabricated from aluminum, and may be fabricated in a stamping process, for example.

The conduit 302 of the thermally conductive plate 300 may be similarly configured to the conduit 116 of the thermally conductive plate apparatus 110 shown in FIG. 1 and FIG. 2. The thermally conductive plate 300 includes a sensor conduit 320 and a groove 322 enclosing the conduit 302, the inlet 304, and the outlet 306.

The thermally conductive plate 300 is shown assembled in FIG. 6. In one embodiment the cover walls 316 and 318 may be adhered to the central wall 312 to provide the required seal. An adhesive having both adhesive and sealing properties, such as a marine grade sealant for example, may be used to bond the cover walls 316 and 318 to the central wall 312. The cover walls 316 and 318 and the central wall may be pressed together in a press apparatus while the adhesive cures to ensure integrity of the seal provided by the adhesive. The adhesive may be applied to surfaces 326 on either side of the central wall 312 to provide an extended bonding and sealing area.

In one embodiment the groove 322 (shown in FIG. 5) provides for an accumulation of adhesive in the groove. The accumulated adhesive in the groove, when cured thus forms a sealing bead that that encloses the fluid flow through the inlet 304, conduit 302 and outlet 306. In other embodiments, a separate sealing element, such as a gasket, o-ring, or molded seal may be introduced in the groove prior to adhering the cover walls 316 and 318 to the central wall 312. The thermally conductive plate 300 also includes fastener openings 324 for receiving the fasteners 164 for use in the battery 100 shown in FIG. 1.

The above embodiments provide a thermally conductive plate for cooling or heating any of a variety of battery cells and may be configured in a stack arrangement for cooling of a large multi-cell battery used in applications such as an electric vehicle, for example. The thermally conductive plate provides a thermal transfer module that includes an integral seal for preventing heat transfer fluids from escaping from the thermally conductive plate and potentially causing battery failure and/or an operating safety hazard. The couplings between the thermally conductive plate couple fluid between the plates and also provide a suitable spacing for accommodating the cells. The embodiments disclosed herein provide for low cost and utilization of simple fabrication and assembly methods and may be implemented for a wide variety of battery cell shapes and configurations. The embodiments also include provisions for constraining thermal expansion of cells.

While specific embodiments of the invention have been described and illustrated, such embodiments should be considered illustrative of the invention only and not as limiting the invention as construed in accordance with the accompanying claims.

What is claimed is:

1. An apparatus for transferring thermal energy to or from a battery cell, the apparatus comprising:
a thermally conductive plate enclosing a conduit, the conduit being in communication with an inlet for receiving a heat transfer fluid stream and being configured to cause the fluid to flow through the thermally conductive plate to an outlet, the thermally conductive plate having a surface for receiving thermal energy generated by operation of the battery cell, the thermally conductive plate being operable to couple thermal energy to the fluid; and
wherein the thermally conductive plate comprises first and second opposing walls, the conduit comprising a first conduit portion formed in the first wall and a second corresponding conduit portion formed in the second wall, and wherein the first and second conduit portions together define the conduit.

2. The apparatus of claim 1 further comprising a seal enclosing the conduit, the inlet, and the outlet, the first and second walls being urged together to cause the seal to be compressed to prevent fluid from escaping from the thermally conductive plate.

3. The apparatus of claim 2 wherein the seal comprises a double seal.

4. The apparatus of claim 3 wherein the double seal comprises first and second seal portions, the first and second seal portions being spaced apart and further comprising a plurality of fasteners received between the first and second seal portions for urging the first and second walls together to cause the double seal to be compressed.

5. The apparatus of claim 4 wherein the plurality of fasteners comprise one of:
a plurality of threaded fasteners; and
a plurality of rivets.

6. The apparatus of claim 2 wherein at least one of the first and second walls comprises a groove formed in the at least one wall for receiving the seal.

7. The apparatus of claim 2 wherein the seal comprises a compressible material having a generally circular cross-section.

8. The apparatus of claim 1 wherein the first and second walls comprise one of a metal, a metal alloy, and a thermally conductive polymer.

9. The apparatus of claim 1 wherein the conduit has a cross-section having a width dimension in a plane of the thermally conductive plate and a depth dimension extending generally perpendicular to the plane of the thermally conductive plate and wherein the width dimension is greater than the depth dimension.

10. The apparatus of claim 1 further comprising a sensor conduit for receiving a temperature sensor for generating a signal representing the temperature of the thermally conductive plate.

11. The apparatus of claim 1 wherein the thermally conductive plate has a generally rectangular shape and the inlet and outlet are respectively disposed at opposite peripheral edges of the thermally conductive plate and wherein the conduit follows a generally serpentine path between the inlet and the outlet.

12. The apparatus of claim 1 wherein at least one of the inlet and the outlet comprises an opening extending through the thermally conductive plate between the first and second walls, the opening being in communication with the conduit and being configured to be coupled to a corresponding opening in an adjacently located thermally conductive plate for receiving the fluid stream.

13. The apparatus of claim 12 wherein the battery cell is disposed between the adjacently located thermally conductive plates and further comprising a coupling configured to couple the fluid stream between the openings in the adjacently located thermally conductive plates.

14. The apparatus of claim 13 wherein the coupling is dimensioned to cause the adjacently located thermally conductive plates to be spaced apart sufficiently to accommodate the battery cell.

15. The apparatus of claim 14 wherein the coupling is dimensioned to cause the adjacently located thermally conductive plates to be spaced apart sufficiently to accommodate the battery cell while constraining thermal expansion of the battery cell when generating thermal energy during operation.

16. The apparatus of claim 13 wherein the coupling is operably configured to receive a seal for sealing between the coupling and the opening.

17. The apparatus of claim 1 wherein the thermally conductive plate comprises a plurality of fastener openings extending through the first and second walls, each fastener opening being configured to receive a fastener for holding a plurality of thermally conductive plates and battery cells in an alternating stack configuration for forming a battery apparatus, the fasteners being further operable to constrain thermal expansion of the battery cell when generating thermal energy.

18. The apparatus of claim 1 wherein the surface for receiving thermal energy generated by operation of a battery cell is generally planar and is dimensioned to generally correspond to a surface of the battery cell that facilitates coupling of thermal energy from the battery cell.

19. A battery apparatus comprising:
at least one battery cell; and
a thermally conductive plate disposed in thermal communication with the at least one battery cell, the thermally conductive plate being configured in accordance with claim 1.

20. The battery apparatus of claim 19 wherein the battery apparatus further comprises first and second end plates disposed on either side of the battery apparatus and wherein the battery apparatus comprises a fluid inlet for receiving the fluid stream and a fluid outlet for discharging the fluid stream, the fluid inlet and the fluid outlet being disposed on one of the first and second end plates, and wherein the fluid inlet is coupled to the inlet of the thermally conductive plate and the fluid outlet is coupled to the outlet of the thermally conductive plate.

21. The apparatus of claim 19 wherein the at least one battery cell comprises a plurality of battery cells each being in thermal communication with at least one thermally conductive plate, and further comprising a coupling configured to couple the fluid stream between the adjacently located thermally conductive plates.

22. The apparatus of claim 21 wherein the coupling is dimensioned to cause the adjacent thermally conductive plates to be spaced apart to accommodate the battery cell.

23. The apparatus of claim 22 wherein the coupling is dimensioned to cause the adjacently located thermally conductive plates to be spaced apart sufficiently to accommodate the battery cell while constraining thermal expansion of the battery cell when generating thermal energy during operation.

24. The apparatus of claim 19 wherein the thermally conductive plate comprises a plurality of fastener openings extending through the first and second walls, and wherein the first and second end plates comprise a corresponding plurality of fastener openings extending though the respective end plates, each fastener openings being configured to receive a fastener for holding the end plates, battery cells and the thermally conductive plate in an alternating stack configuration for forming a battery apparatus, the fasteners being further operable to constrain thermal expansion of the battery cell when generating thermal energy.

25. An apparatus for transferring thermal energy to or from a battery cell, the apparatus comprising:
a thermally conductive plate enclosing a conduit, the conduit being in communication with an inlet for receiving a heat transfer fluid stream and being configured to cause the fluid to flow through the thermally conductive plate to an outlet, the thermally conductive plate having a surface for receiving thermal energy generated by operation of the battery cell, the thermally conductive plate being operable to couple thermal energy to the fluid; and
wherein the conduit comprises an aperture in a central wall of the thermally conductive plate, and wherein the thermally conductive plate further comprises first and second cover walls on either side of the central wall, the cover walls enclosing the aperture and providing a seal for preventing fluid from escaping from the thermally conductive plate.

26. The apparatus of claim 25 wherein the central wall comprises one of a plastic material, a metal, and a metal alloy.

27. The apparatus of claim 25 wherein the cover walls each comprise at least one of a metal, a metal alloy, and a thermally conductive polymer.

28. The apparatus of claim 25 wherein the central wall is formed using at least one of:
a machining process;
a molding process; and
a stamping process.

29. The apparatus of claim 25 wherein the cover walls are adhered to the central wall to provide the seal.

30. The apparatus of claim 29 wherein the central wall comprises a groove formed in the central wall and enclosing the conduit, the inlet, and the outlet, the groove being operable to receive an adhesive for providing a seal for preventing fluid from escaping from the thermally conductive plate.

31. The apparatus of claim 29 wherein the central wall comprises a groove formed in the central wall and enclosing the conduit, the inlet, and the outlet, the groove being operable to receive a seal for preventing fluid from escaping from the thermally conductive plate.

32. The apparatus of claim 25 wherein the conduit has a cross-section having a width dimension in a plane of the thermally conductive plate and a depth dimension extending generally perpendicular to the plane of the thermally conductive plate and wherein the width dimension is greater than the depth dimension.

33. The apparatus of claim 25 further comprising a sensor conduit for receiving a temperature sensor for generating a signal representing the temperature of the thermally conductive plate.

34. The apparatus of claim 25 wherein the thermally conductive plate has a generally rectangular shape and the inlet and outlet are respectively disposed at opposite peripheral edges of the thermally conductive plate and wherein the conduit follows a generally serpentine path between the inlet and the outlet.

35. The apparatus of claim 25 wherein at least one of the inlet and the outlet comprises an opening extending through the thermally conductive plate between the first and second walls, the opening being in communication with the conduit and being configured to be coupled to a corresponding opening in an adjacently located thermally conductive plate for receiving the fluid stream.

36. The apparatus of claim 35 wherein the battery cell is disposed between the adjacently located thermally conductive plates and further comprising a coupling configured to couple the fluid stream between the openings in the adjacently located thermally conductive plates.

37. The apparatus of claim 36 wherein the coupling is dimensioned to cause the adjacently located thermally conductive plates to be spaced apart sufficiently to accommodate the battery cell.

38. The apparatus of claim 37 wherein the coupling is dimensioned to cause the adjacently located thermally conductive plates to be spaced apart sufficiently to accommodate the battery cell while constraining thermal expansion of the battery cell when generating thermal energy during operation.

39. The apparatus of claim 36 wherein the coupling is operably configured to receive a seal for sealing between the coupling and the opening.

40. The apparatus of claim 25 wherein the thermally conductive plate comprises a plurality of fastener openings extending through the first and second walls, each fastener opening being configured to receive a fastener for holding a plurality of thermally conductive plates and battery cells in an alternating stack configuration for forming a battery apparatus, the fastener being further operable to constrain thermal expansion of the battery cell when generating thermal energy.

41. The apparatus of claim 25 wherein the surface for receiving thermal energy generated by operation of a battery cell is generally planar and is dimensioned to generally correspond to a surface of the battery cell that facilitates coupling of thermal energy from the battery cell.
